(19) United States
(12) Patent Application Publication
(10) Pub. No.: US 2005/0132766 A1
(43) Pub. Date: Jun. 23, 2005

(54) Lock assembly

(76) Inventor: Thomas K. Milo, Akron, OH (US)

Correspondence Address: John P. Cornely, Esq.;Fay, Sharpe, Fagan, Minnich & McKee, LLP, Seventh Floor, 1100 Superior Avenue, Cleveland, OH, 44114-2518, US

(21) Appl. No.: 11/013,818

(22) Filed: Dec. 16, 2004

Related U.S. Application Data
(60) Provisional application No. 60/531,863, filed on Dec. 22, 2003.

(51) Int. Cl. E05B 47/00

(52) U.S. Cl. 70/279.1

(57) ABSTRACT

An automated assembly for operating a lock in a door includes a housing, a lock conversion assembly, and a powered drive mechanism. The housing includes an opening dimensioned to receive a lock cylinder that has been removed from a lock in a door to which the assembly can mount. The lock conversion assembly extends from the housing and can be received in the opening in the door once occupied by the mortise and/or rim cylinder. The lock conversion assembly operates the door lock. A method for converting a manual cylinder lock to an automated lock is also provided. A deadbolt lock assembly is also disclosed.

This application claims the benefit of U.S. Provisional Patent Application Ser. No. 60/531,863 filed Dec. 22, 2003, which is incorporated by reference.

### BACKGROUND OF THE INVENTION

Conventional mortise cylinder and rim cylinder locks are ubiquitous in commercial and retail environments. Each conventional mortise cylinder lock and rim cylinder lock includes a cylinder made of metal, typically brass that fits into a circular opening in a door lock. The cylinder includes a key opening on an outer face. The key opening leads to a smaller diameter cylinder, also known as a plug, that includes a plural pin tumbler. The plug is typically offset from the central axis of the cylinder. A cam which is typically a cylindrical component having an appendage extending from its periphery for a mortise cylinder lock or a straight cam, which is also known as a connecting bar or spindle, for a rim cylinder lock attaches at an end of the plug opposite the key opening. The cam, which can be many different shapes dependant upon the manufacturer of the lock, cooperates with the lock of the door. With the proper key inserted into the key opening, the tumblers align allowing the key to turn resulting in the cam turning and operating the lock.

### BRIEF DESCRIPTION OF THE FIGURES

FIG. 1 is a front perspective view of an automated lock adapter assembly.

FIG. 2 is a rear perspective view of the automated assembly of FIG. 1 having an original lock cylinder and two lock adapter assemblies exploded from a housing of the automated assembly.

FIG. 3 is an exploded view of the automated assembly of FIG. 1 without the adapter assemblies and with the original lock cylinder.

FIG. 4 is an exploded view of the mortise cylinder adapter assembly of FIG. 2.

FIG. 5 is an exploded view of the rim cylinder adapter assembly of FIG. 2.

FIG. 6 is a side view of the lock adapter assembly and a transmission that is disposed in the housing of the automated assembly of FIG. 1.

FIG. 7 is an exploded view of a handle assembly for use with the automated assembly of FIG. 1.

FIG. 8 is a perspective view of a rotary deadbolt assembly exploded from the automated lock assembly of FIG. 1.

FIG. 9 is an exploded view of the rotary deadbolt assembly depicted in FIG. 8.

FIG. 10 is a side isometric view of a transmission and rotary deadbolt for the rotary deadbolt assembly depicted in FIG. 8.

FIG. 11 is a bottom isometric view of the transmission and rotary deadbolt of FIG. 10.

FIG. 12 is a side view of the transmission and rotary deadbolt of FIG. 10.

FIG. 13 is a top view of the rotary deadbolt and transmission of FIG. 10.

FIG. 14 is a top exploded view of a rack and tail of the transmission of FIG. 10.

FIG. 15 is a bottom exploded view of the rack and tail of FIG. 14.

FIG. 16 is a front view of the rotary deadbolt assembly of FIG. 8 in a right-hand configuration with a deadbolt extended.

FIG. 17 is a top view of the rotary deadbolt assembly of FIG. 16.

FIG. 18 is a front view of the rotary deadbolt assembly of FIG. 8 in a left-hand configuration with deadbolt extended.

FIG. 19 is a linear deadbolt assembly exploded from the automated lock assembly of FIG. 1.

FIG. 20 is an exploded view of the linear deadbolt assembly depicted in FIG. 19.

FIG. 21 is a top view of the linear deadbolt assembly of FIG. 19.

FIG. 22 is a front view of the linear deadbolt assembly of FIG. 19.

FIG. 23 is a side isometric view of a linear deadbolt and transmission of the linear deadbolt assembly of FIG. 19.

FIG. 24 is a top isometric view of the linear deadbolt and transmission of FIG. 23.

FIG. 25 is a top view of the linear deadbolt and transmission of FIG. 23.

FIG. 26 is a side view of the linear deadbolt and transmission of FIG. 23.

### SUMMARY OF THE INVENTION

An automated assembly for operating a lock in a door includes a housing, a lock adapter assembly, a powered drive mechanism, and a conversion cam. The housing includes an opening dimensioned to receive an associated lock cylinder that is typically removed from the lock in the door to which the assembly will mount. The lock adapter assembly includes a portion extending away from the housing and shaped to be received in an opening in an associated door lock that was once occupied by the associated lock cylinder. The lock adapter assembly includes a mounting member for mounting an associated cam that corresponds to the associated lock cylinder. The conversion cam can mount to the associated lock cylinder and cooperate with the lock adapter assembly and/or the powered drive mechanism such that movement of the conversion cam results in the mounting member moving the associated cam to operate the associated door lock.

A method for converting a manual cylinder lock, e.g. a mortise cylinder or a rim cylinder, to an automated lock includes the following steps: removing a lock cylinder from a door lock so that a cylindrical opening remains in the door; removing a cam that cooperated with the door lock from the lock cylinder; attaching the cam from the lock cylinder to a lock adapter assembly of an automated lock assembly; and mounting the automated lock assembly to the door such that at least a portion of the lock adapter assembly fits into the cylindrical opening of the door.

The automated assembly can also cooperate with a deadbolt assembly to provide an automated lock. In one embodiment the assembly includes a housing that is adaptable between a right-hand and left-hand configuration. A gear train that is disposed in the housing is also easily configurable to drive a rotary deadbolt for either a left-hand or right-hand configuration. The housing can also be adaptable to accommodate a linear deadbolt assembly through either a top or bottom of the housing.

### DETAILED DESCRIPTION OF THE INVENTION

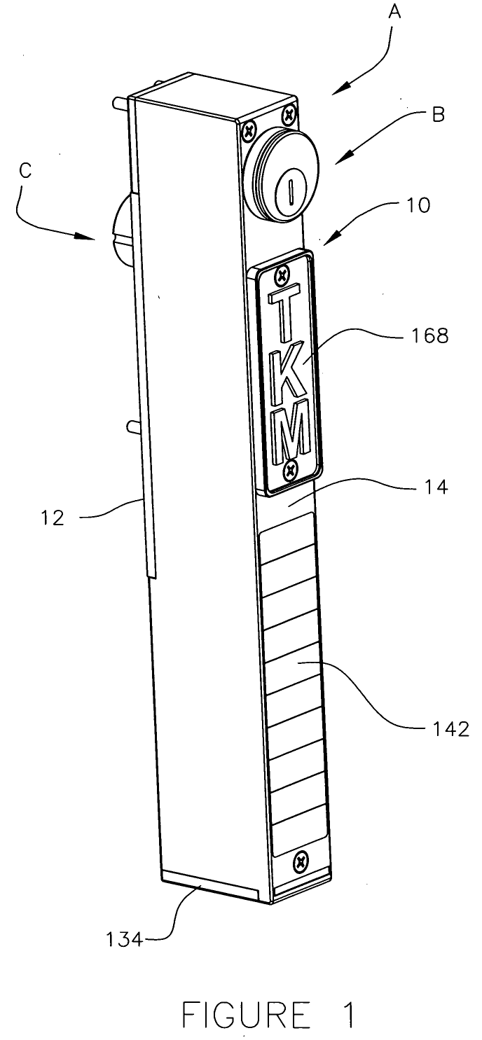

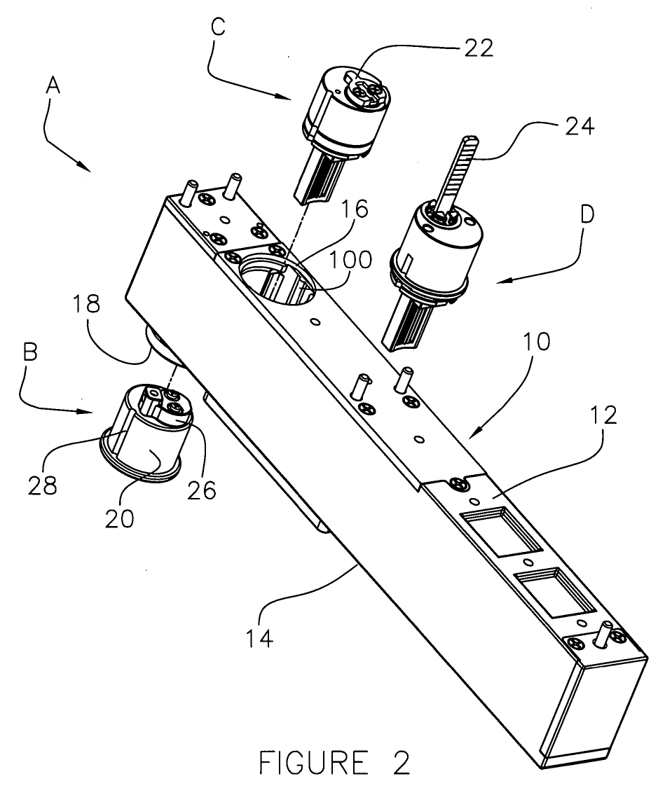

With reference to FIG. 1, an automated lock assembly A includes a housing 10 that can attach to a door and/or door lock (not shown). The door lock can already include a mortise cylinder or a rim cylinder, both referred to as an original lock cylinder B, that is operatively connected to a lock of the door (not shown). With reference to FIG. 2, when using the automated lock assembly A, the original lock cylinder B that is mounted to the door is removed prior to mounting the housing 10 to the door. The housing 10 has a plurality of connected walls including a first wall 12 positioned adjacent the door when the assembly A is mounted to the door and a second wall 14 that is spaced from and parallel to the first wall. The first wall 12 includes a first opening 16 that receives a lock adapter assembly, either a mortise cylinder adapter assembly C or a rim cylinder adapter assembly D. The second wall 14 includes a second opening 18 that is offset from the first opening 16 that receives the original lock cylinder B, which has been removed from the door.

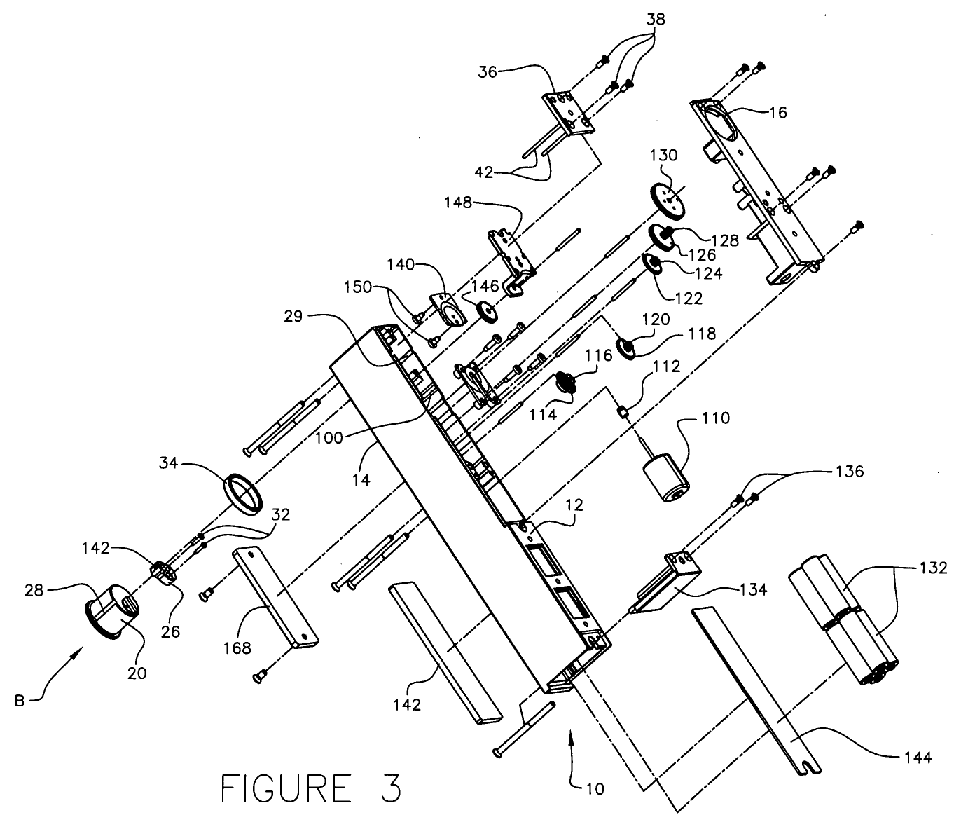

The automated lock assembly A can lock and/or unlock the door lock once operated by the original lock assembly B either automatically, e.g. remotely, using a key of the original lock cylinder B, or using other sensor devices. Each original lock cylinder B, both the mortise cylinder and the rim cylinder, includes a cylindrical housing 20 that can include two grooves 28 (only one shown in FIG. 2) that cooperate with pins in the door lock so that the cylinder cannot be unscrewed from the door lock without first removing the pins. An original cam, which can be a cam 22 comprising cylindrical component having an appendage for the mortise cylinder or a straight cam 24 for the rim cylinder, mounts to the cylindrical housing 20 of the original lock cylinder. The original cam 22, 24 cooperates with the lock found in the door to which the automated lock assembly A will mount. Before inserting the original cylindrical housing 20 into the second opening 18, the original cam 22, 24 is removed and a conversion cam 26 using fasteners 32 (FIG. 3) or a clip (not shown) is mounted to the original cylinder 20. The original cam 22 for the original mortise cylinder attaches to the mortise cylinder adapter C and the original cam 24 for the rim cylinder attaches to the rim cylinder adapter D. The cams can mount to the cylinders in other conventional manners.

The original cylinder B mounts inside the second opening 18 by screwing the original cylinder into the opening. In such a configuration the original cylinder B includes threads and the housing 10 includes corresponding threads. Alternatively, the original cylinder B mounts in the housing 10 by using rear mounting screws; however, it is understood that the original cylinder B can mount inside the housing in other conventional manners. With reference to FIG. 3, a spacer ring 34 can be provided sandwiched between the cylindrical housing 20 and the second wall 14 to provide for proper spacing and alignment for the cylindrical housing. A removable lid 36 attaches to the rear of the housing 10 using fasteners 38. Locking pins 42 extend from the lid 36 into the housing and are received in the grooves 28 of the cylindrical housing 20 and in grooves 29 of the housing 10 (only one shown in FIG. 3) so that the cylindrical housing cannot be unscrewed without removing the lid 36.

With reference back to FIG. 2, the lock adapter assemblies C and D operate the lock in the door. Both adapter assemblies C and D fit, only one at a time, into both the first opening 16 of the housing 10 and the opening in the door lock where the original cylinder B was located. Both cylinder adapters include a similar gear train to operate the lock of the door, which allows for easier manufacture of the assembly.

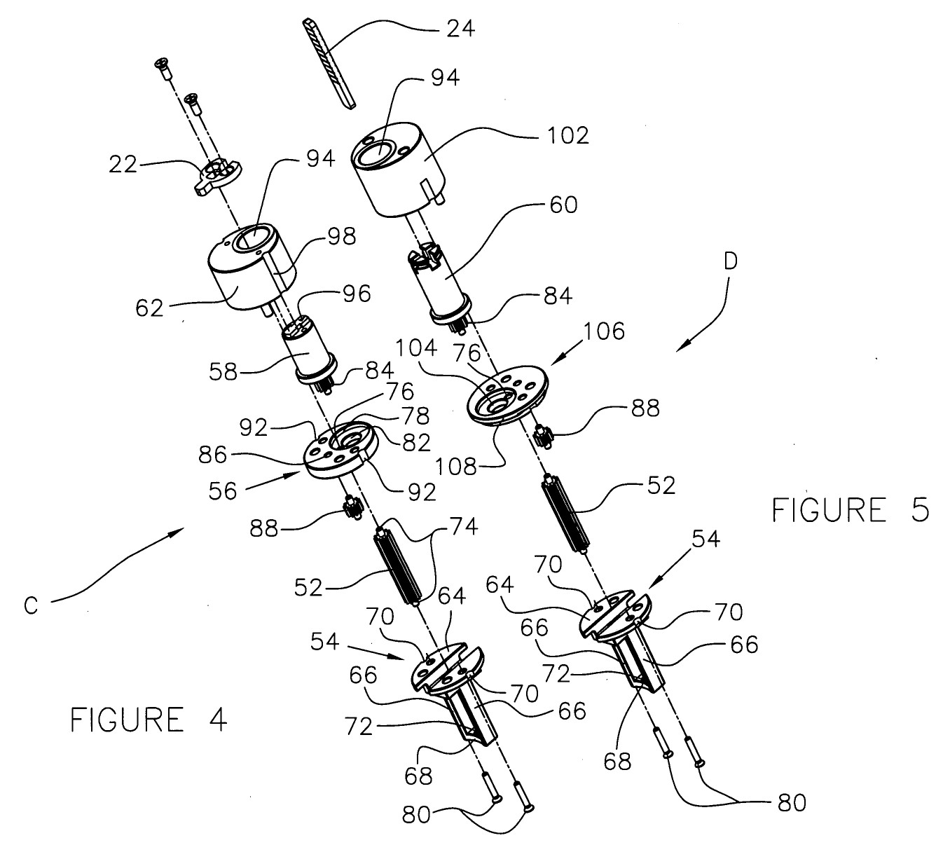

With reference to FIG. 4, the mortise lock adapter assembly C includes an elongated driven gear 52 mounted to a gear mounting chassis 54. The gear mounting chassis 54 includes a plate 64 having a pair of parallel struts 66 extending normally from the plate. A brace 68 interconnects the struts 66 at an end opposite the plate. The gear mounting chassis 54 also includes two alignment grooves 70 that are similar to the alignment grooves 28 on the original cylinder 20.

The driven gear 52 mounts between the struts 66 to the brace 68 at one end and to a gear mounting plate 56 at an opposite end. More specifically, the brace 68 includes an opening 72 that receives an axle 74 of the driven gear 52 and the gear mounting plate 56 also includes an aligned opening 76 that receives the axle 74. The driven gear 52 is elongated, which allows for the lock adapter assembly to be easily adjusted, which will be described in more detail below.

The gear mounting plate 56 attaches to the gear mounting chassis 54 using fasteners 80 and includes a circular depression 78 that receives a cam mounting member 58. The circular depression 78 is offset from the central axis of the gear mounting plate 56 and the mortise lock adapter assembly C. This is similar to the offset of the plug in a conventional lock cylinder. A first gear opening 82 is located in the center of the circular depression 78. An output drive gear 84, which is mounted to the cam mounting member 58, protrudes through the gear opening 82 so that the output drive gear 84 engages the driven gear 52. The gear mounting plate 56 includes a second gear opening 86, which is located directly above the first gear opening 82, perpendicular to the central axis. An auxiliary gear 88 mounts in the opening 86 and also engages the driven gear 52. The gear mounting plate also includes two grooves 92 that align with the two grooves 70 on the gear mounting chassis 54.

A cylindrical housing 62 attaches to the gear mounting plate 56 and the plate 64 of the gear mounting chassis 54. The housing 62 receives the cam mounting member 58. The housing 62 includes a cam opening 94 that is offset from the central axis of the base 62 and the assembly C and aligned with the circular depression 78 of the gear mounting plate 56. The cam mounting member 58 includes a cam mount 96 on an end of the cam mounting member 58 opposite from and operatively connected to the output drive gear 84. The original cam 22, which was removed from the original mortise cylinder B, attaches to the cam mount 96 and protrudes through the cam opening 94 of the housing 62. Movement of the driven gear 52 results in movement of the original cam 22 to operate the lock of the door to which the automated assembly mounts.

The housing 62 also includes alignment grooves 98 (only one visible in FIG. 4) that align with the grooves 70 and 92. The alignment grooves 70, 92 and 98 align with and receive semicyindrical sidewall protrusions 100 (FIG. 3) in the housing 10.

The rim cylinder adapter assembly D depicted in FIG. 5 includes many of the same components as the mortise cylinder adapter assembly C depicted in FIG. 4. Many of the reference numerals used to describe the mortise cylinder adapter assembly C will also be used to describe the rim cylinder adapter assembly D. This is simply for the sake of brevity and ease of understanding FIG. 5. It is to be understood that other assemblies and components can be used and the embodiments disclosed are not to be limited to only those assemblies and components described.

With reference to FIG. 5, the rim cylinder adapter includes the driven gear 52 mounted to the gear mounting chassis 54. The driven gear 52 mounts between the struts 66 of the chassis 54 and drives an output drive gear 84 that extends through an opening 82 in a gear mounting plate 106. The gear mounting plate 106 for the rim cylinder adapter can include a cylindrical rim 108 extending from the periphery of the plate 106. The rim 108 is similar to a rim found on a conventional rim cylinder. The output drive gear 84, however, attaches to a straight cam or spindle mounting member 60. The original straight cam 24 mounts to an end of the cam mounting member 60 using a clip as know in the art. The original cam 24 mounts opposite the output drive gear 84 and extends through an opening 94 in a housing 102 that receives the cam mounting member. The housing 102 is similarly shaped to the housing 62 of the mortise cylinder adapter assembly; however, the housing 102 for the rim cylinder adapter assembly includes grooves 98 that do not run the length of the housing. The housing 102 can take other configurations than cylindrical.

Since the original cam 22 that attaches to the mortise cylinder adapter assembly C and the original cam 24 that attaches to the rim cylinder adapter cylinder D engages the lock of the door, each lock assembly C and D protrudes into the door. The depth that each assembly C and D protrudes from and into the housing 10, thus the portion that can protrude into the opening of the door lock, can be adjusted to accommodate doors of different thickness. With reference to FIG. 6, the elongated driven gear 52 can engage a transmission that will be described in more detail below anywhere along the length of the driven gear. Accordingly, the additional depth that each assembly C and D can protrude is equal to the dimension “x” depicted in FIG. 6. FIG. 6 depicts the mortise cylinder adapter assembly C; however, the transmission can operate the rim cylinder adapter assembly also. Furthermore, an elongated member, for example a rod or the like can be used instead of the elongated driven gear 52 to provide an adjustable assembly. The rod can cooperate with a transmission similar to that described below. Such a configuration may obviate the need for mounting struts 66.

Additionally, each adapter assembly C and D can be rotated 180 degrees to reposition the cam mount 96 in the mortise cylinder adapter assembly C or the cam mounting member 60 in the rim cylinder adapter assembly D. In some doors the key cylinder is offset above the central axis of the lock cylinder; however, to automate these door locks it may be impractical to rotate the entire housing 10 of the automated lock assembly A so that it is mostly above the adapter assembly C or D. Since the driven gear 52 of the mortise cylinder adapter assembly C and the rim cylinder adapter assembly D is located on the central axis of the assembly, the assembly can be rotated 180 degrees and inserted into the first opening 16 of the housing 10 without affecting the alignment of the driven gear 52, while changing the location of the cam mount 96 or the cam mounting member 60 so that it can work with this type of door lock. The alignment grooves 70, 92 and 98 still align with the grooves 100 in the housing 10 with the assembly rotated 180 degrees.

The driven gear 52 can be driven automatically. With reference to FIGS. 3 and 6, a motor 110 drives the driven gear 52 through a transmission made up of a plurality of gears. Alternatively, the transmission can comprise belts, pulleys and the like. In the embodiment depicted, the transmission is a gear reduction transmission; however, other conventional transmissions can be used. Also, the driven gear 52 can be driven automatically by a solenoid or similar device. In the embodiment depicted, the motor 110 drives a pinion 112 that drives a beveled gear 114 having a second pinion 116 attached and concentric thereto. The second pinion 116 drives a first intermediate gear 118 that has a third pinion 120 attached and concentric thereto. The third pinion 120 drives a second intermediate gear 122 that also has a fourth pinion 124 attached and concentric thereto. The fourth pinion 124 drives a third intermediate gear 126 that has a fifth pinion 128 attached and concentric thereto. The fifth pinion 128 engages a fourth intermediate gear 130 which engages the driven gear 52.

The motor 110 is driven by a power source, which can be an internal source such as batteries, an external source such as from an AC power source or a renewable source such as solar cells. As seen in FIG. 3, batteries 132, which in the depicted embodiment are rechargeable batteries, are disposed inside the housing 10 to provide a power source for the motor 110. A removable lower door 134 attaches to the housing 10 using fasteners 136 to provide access to the batteries 132. A solar cell 142 mounts to a lower portion of the front of the housing 10 to provide energy to the motor 110 and/or the batteries 132 for recharging. The solar cell can be a flexible thin film cell of the type known in the art. An internal power supply allows the assembly A to be easily mounted to the door lock without having to provide electrical wiring to the assembly. As compared to known devices, not having to provide an electrical connection provides significant cost savings on installation of the assembly. Many times the assembly A is mounted where there is a light source, e.g. outside, and therefore the solar cell 142 can be used to separately power the motor 110 without using the batteries and the solar cell can also recharge the batteries. Accordingly, the life of the power supply can be relatively long, for example on the order of 10 years.

The motor can also communicate with a circuit board 144 to which sensors can mount to receive a signal that determines when to drive the motor. For example, the sensors can be RF sensors that can communicate with an RF transmitter. IR sensors and other conventional sensors can also be used. This would allow the lock on the door to be locked and unlocked remotely using a key fob or similar device. The circuit board 144 can also communicate with other conventional electronic equipment, e.g. a hard wired unit, to control the power delivered to the motor. The circuit board 144 mounts behind the solar cell 142 so that the sensors on the circuit board 144 can receive a signal.

In addition to being remotely activated, the driven gear 52 can be rotated, and thus the lock of the door can be activated using a key that operates the original lock cylinder B. With reference back to FIG. 3, a circuit board 140 mounts inside the housing 10 near the second opening 18. In one embodiment, a Hall effect sensor mounts to the circuit board 140 and a magnet 142 mounts to the conversion cam 26. The circuit board 140 communicates with the power source 132. Rotation of the key in the original lock cylinder B turns the conversion cam 26. The magnet 142 on the conversion cam 26 activates the Hall effect sensor to deliver a signal to the power source 132 to drive the motor 110 to lock or unlock the door lock. Other known position sensors are also contemplated to provide a signal to the power source 132.

The driven gear 52 can also be rotated manually when the key in the original lock cylinder is rotated. The conversion cam 26 can include teeth that engage a conversion gear 146 that is mounted to an upper gear mounting plate 148. The circuit board 140 also mounts to the gear mounting plate 148 using conventional fasteners 150. As seen in FIG. 6, the conversion gear 146 engages the driven gear 52. Accordingly, rotation of the conversion cam 26 results in rotation of the conversion gear 146 which results in rotation of the driven gear 52.

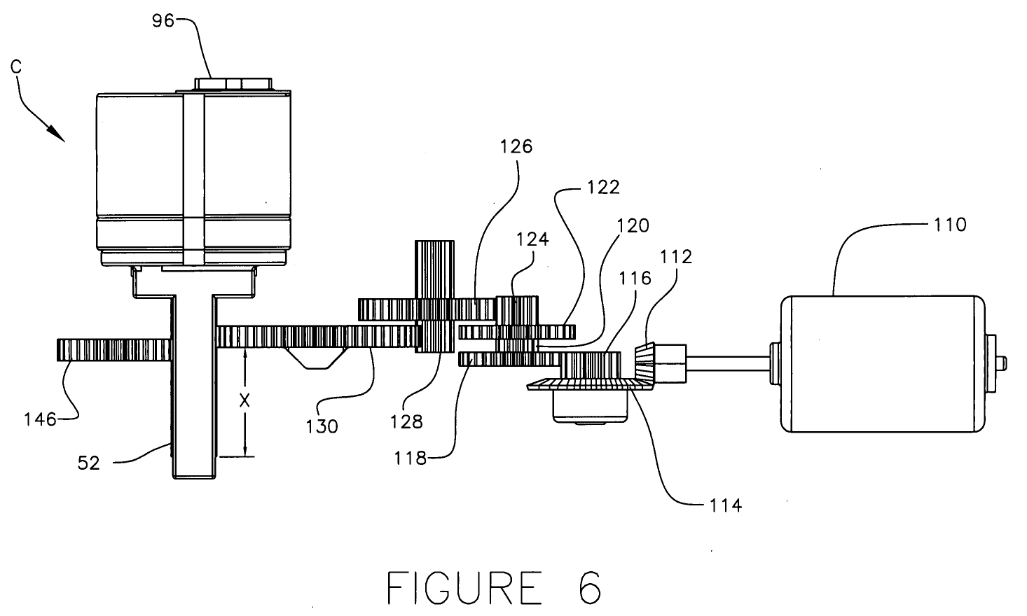

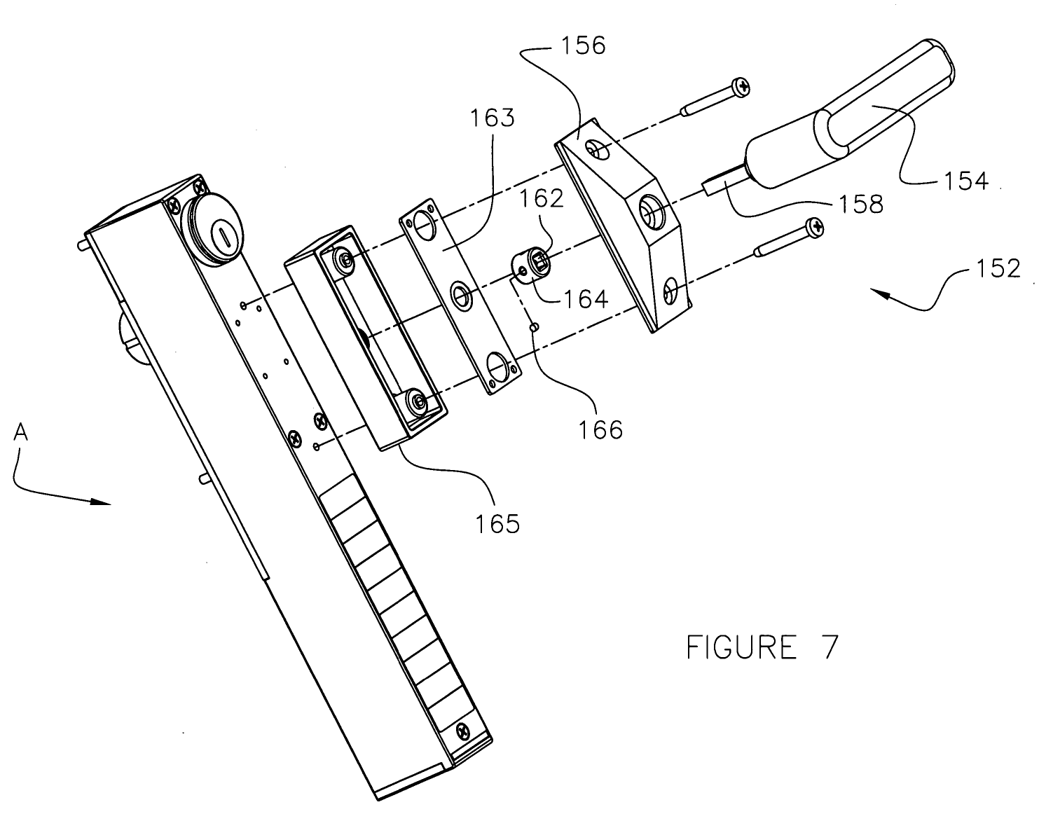

The sensor on the circuit board 144 can also receive a remote signal from a handle assembly 152 (FIG. 7) that can mount to the front of the automated assembly A. The handle assembly 152 includes a handle 154 that mounts to an escutcheon 156. A spindle 158 connects to the handle 154 and extends away from a side of the escutcheon 156 opposite the handle. The spindle 158 is matingly received in a corresponding opening 162 of a cam plug 164. A magnet 166 attaches to the cam plug 164 and rotation of the handle results in rotation of the cam plug. The magnet 166 operates a Hall effect sensor mounted to a circuit board 163, similar to the one described above, to deliver a signal to the circuit board 144. Other sensors can also be used. The cam plug 164 and sensor components mount inside a protective housing 165 that mounts to the assembly A. The escutcheon 156 and housing 165 mount to the assembly housing 10. To mount the handle assembly 152 to the housing 10, a front plate 168 (FIG. 3) which has similar dimensions to the escutcheon 156 can be removed from the housing. The handle assembly 152 provides yet another wireless actuator for the automated assembly A. Also, the handle assembly 152 can mount elsewhere, for example to a nearby wall. The handle assembly 152 can also be hardwired to the circuit board 144. Since the handle assembly 152 includes a rotating cam 164, two or more Hall effect sensors can be positioned on the circuit board 163 to provide different signals, for example a lock or unlock signal determined by the rotational position of the magnet 166.

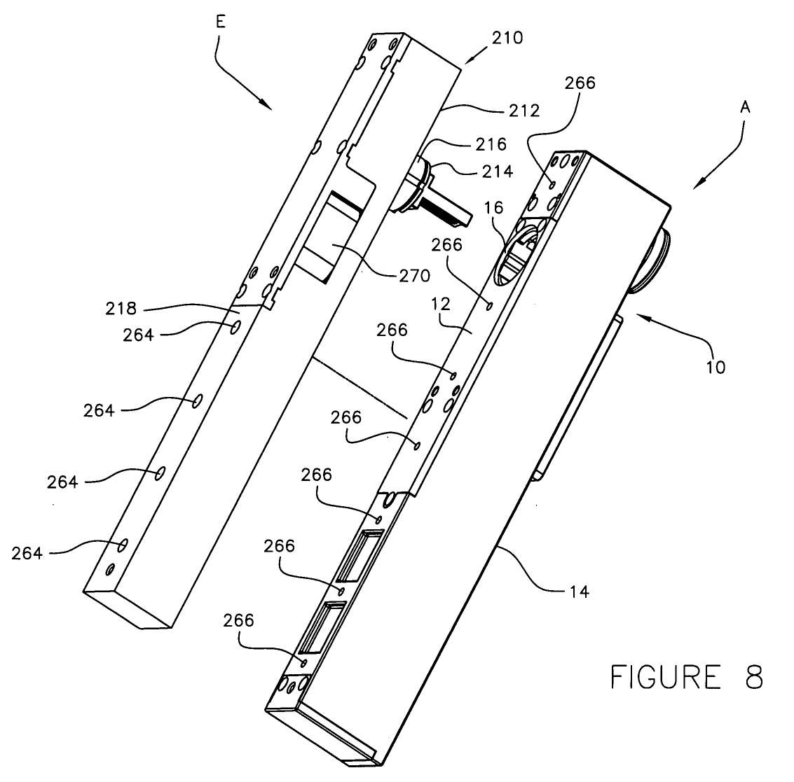

With reference to FIG. 8, the automated lock assembly A described above can cooperate with a rotary deadbolt assembly E to provide a deadbolt lock assembly. The rotary deadbolt assembly E includes a housing 210 having a plurality of connected walls including a first wall 212 that will abut the first wall 12 of the housing 10 of the automated lock assembly A when the two assemblies are attached to one another. A gear mounting chassis 214, which can be similar in configuration to the gear mounting chassis 54 described above, mounts to a cylindrical boss 216 using fasteners 215. The gear mounting chassis 214 and the cylindrical boss 216 align with the first opening 16 in the first wall 12 of the housing 10 of the automated lock assembly A when the automated lock assembly A and the rotary deadbolt assembly E are attached to one another. The housing 210 also includes a second wall or rear wall 218 that is spaced from and parallel to the first wall 212.

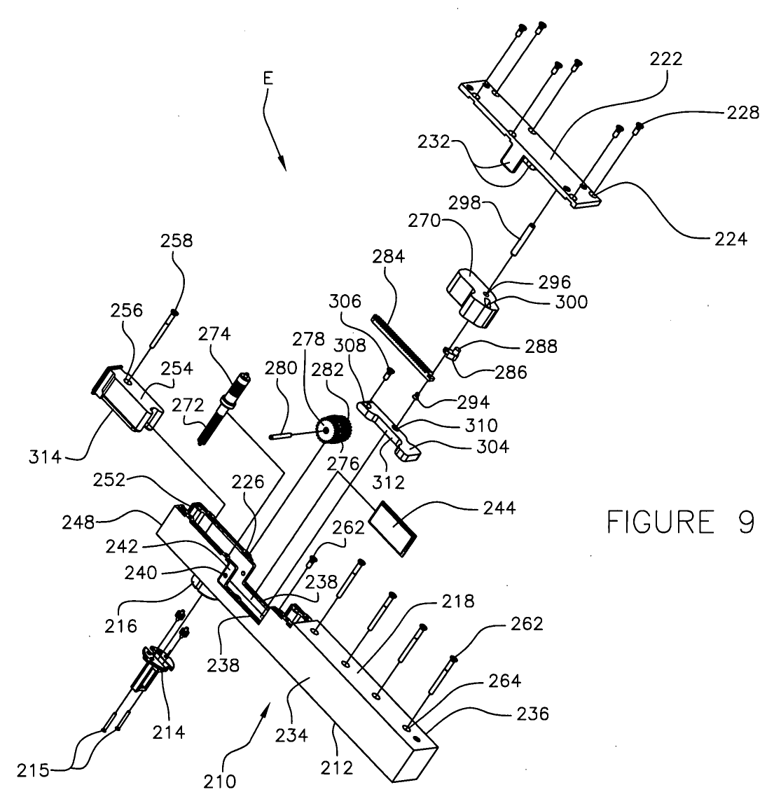

As more clearly seen in FIG. 9, a removable rear panel 222 selectively attaches to the housing 210. The removable rear panel 222 can be removed from the housing to provide access to internal components of the rotary deadbolt assembly E, which will be described in more detail below. The removable rear panel 222 includes a plurality of openings 224 that align with openings 226 in the housing to receive fasteners 228 to attach the removable rear panel 222 to the housing 210. Even though fasteners are shown to attach the removable rear panel 222 to the housing 210, the rear panel 222 can attach to the housing via a resilient snap fit or in any conventional manner. The removable rear panel 222 includes a pair of appendages 232 that extend from opposite lateral edges of the rear panel substantially normal to an exposed rear surface of the rear panel.

The housing 210 also includes a first side wall 234 and a second side wall 236 connecting the front wall 212 to the rear wall 218. Each side wall is similarly shaped, and therefore for the sake of brevity, only the first side wall 234 will be described in detail. Each side wall 234 and 236 includes a cut-out 238 extending from the edge of the first side wall that abuts the removable rear panel 222 toward the front wall 212. Each side wall 234 also includes a recessed surface 242 adjacent the cut-out 238. Similar to the cut-out 238, the recessed surface 242 begins at an edge of the first side wall 234 that is adjacent the rear panel 222 and extends towards the front wall 212. In the embodiment depicted, the recessed surface 242 is adjacent an upper end of the cut-out 238. An opening 240 is provided in each recessed surface 242. When the removable rear panel 222 mounts to the housing 210, the appendages 232 cover the recessed surface 242 such that the appendage 232 is flush with the remainder of the corresponding side wall, either 234 or 236. Side wall covers 244 (only one shown) are provided to selectively cover the cut-out 238 in either side wall 234 or 236. In the rotary deadbolt assembly depicted, typically only one side wall cover 244 is used so that one cut-out 238, either a left-hand or right-hand cut-out, is not covered.

The housing 210 also includes a top wall 248 (FIG. 17) that interconnects and is normal to each of the front wall 212, the rear wall 218, and the side walls 234, 236. The top wall 248 defines a top cut-out 252 that extends into the top wall from an edge of a top wall adjacent the rear panel 222. A top cover member 254 is provided to cover the top cut-out 252. The top cover member 254 includes an opening 256 that receives a fastener 258 to allow the top cover member 254 to attach to the housing 210 and the housing 10 of the automated lock assembly A. Accordingly, the top cover member 254 is selectively removable from the housing 210, which will be described in more detail below.

With reference to both FIGS. 8 and 9 mounting screws 262 fit into openings 264 in the rotary deadbolt assembly housing 210 which are received in openings 266 in the automated lock assembly housing 10. Accordingly, the rotary deadbolt assembly housing 210 can attach to the automated lock assembly housing 110; however, in alternative embodiments one housing can be provided to house the components of both the rotary deadbolt assembly E and the automated lock assembly A. Longer fasteners can be provided where the fastener extends through the rear wall 218 and the front wall 212, and shorter fasteners can be provided where the fastener only extends through the front wall 212.

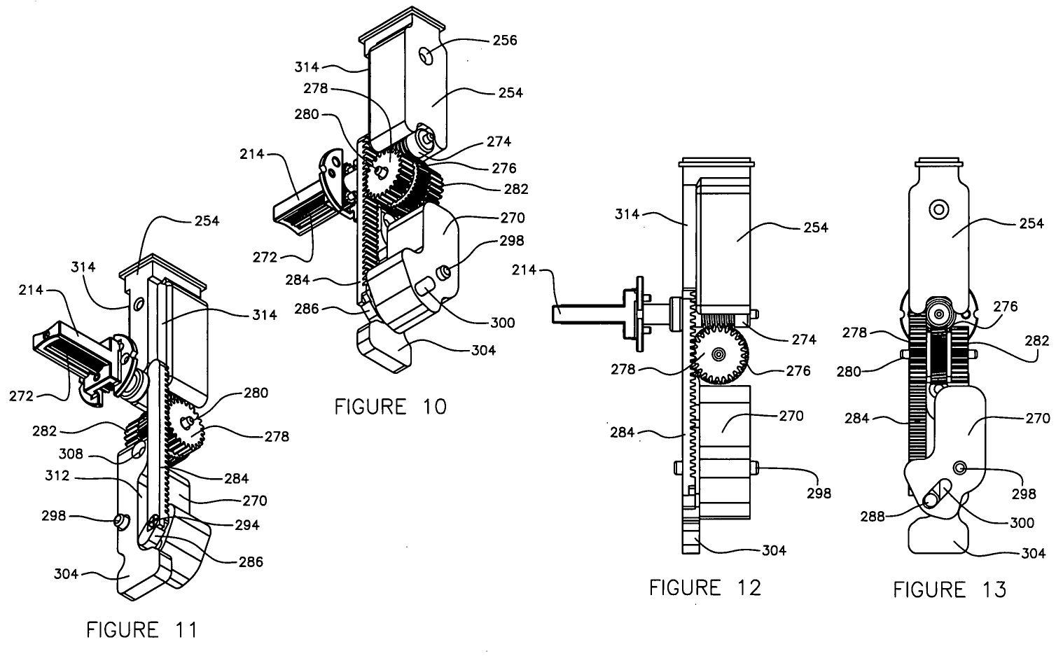

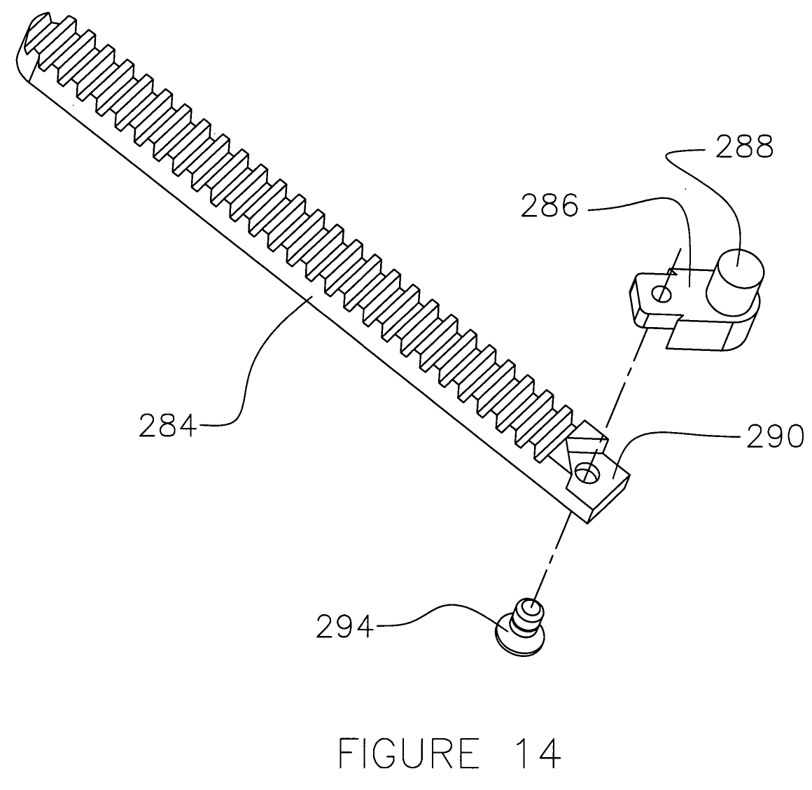

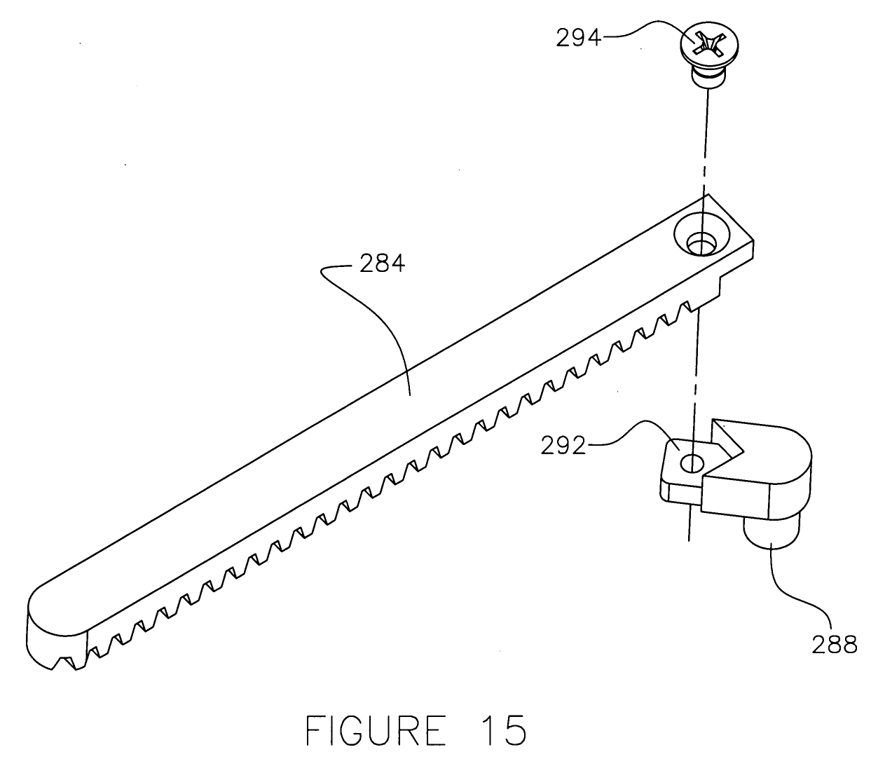

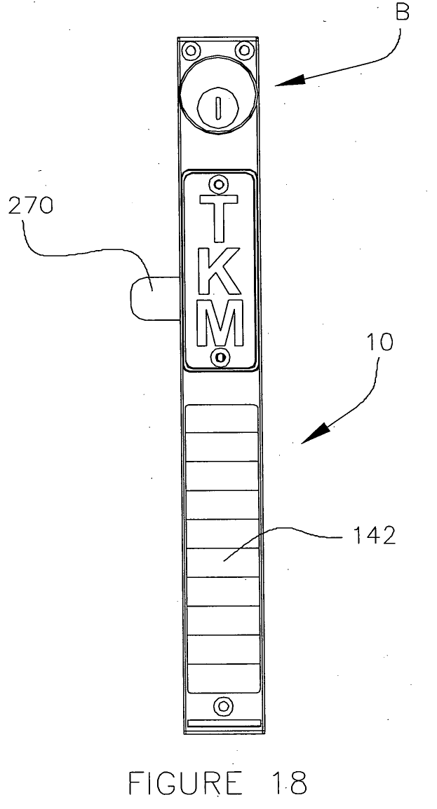

A rotary deadbolt 270 and a gear train for the rotary deadbolt are disposed in the housing 210. The gear train includes a worm gear assembly, which inhibits one from prying the deadbolt to unlock the door. An axially elongated gear 272, similar to the axially elongated gear for the automated assembly A, has a worm 274 extending concentrically from the gear. As more clearly seen in FIGS. 10-13, the worm 274 engages a corresponding worm gear 276. A first pinion 278 is concentric with and connected to the worm gear 276 and a second pinion 282 is concentric with and attached on an opposite side of the worm gear. The first pinion 278, the second pinion 282 and the worm gear 276 rotate about an axle 280 that is received in the openings 240 in the recessed surface 242 (FIG. 9). The appendages 232 on the rear panel 222 lock the axle 280 and gears 276, 278 and 282 in place. For a left-hand configuration, such as that shown in FIGS. 10-13 and 18, the first pinion 278 engages a rack 284. A removable tail 286 having a pin 288 extending in a direction perpendicular to the plane in which the rack 284 will move attaches to the rack. With reference to FIGS. 14 and 15, the rack 284 includes a V-shaped notch 290 at a lower end where the tail attaches. The tail 286 also includes a V-shaped notch 292. The lower notch 290 of the rack 284 receives a portion of the tail 286 and the notch 292 in the tail 286 bears against a side of the rack 284. A fastener 294 attaches the tail 286 to the rack 284. The notches 290 and 292 allow the tail 286 to fasten to the rack in two different orientations to allow the rack to operate a left-hand and right-hand rotary deadbolt.

With reference back to FIGS. 10-13, the axially elongated gear 272 is driven by the transmission described above in the automated lock assembly A or another suitable transmission. The elongated gear 272 drives the worm 274, which drives the corresponding worm gear 276, which is attached to the second pinion 278. The second pinion 278 engages the rack 284 moving the rack vertically and linearly.

The deadbolt 270 is somewhat L-shaped and includes a first circular opening 296 (FIG. 9) that receives a pin 298 about which the deadbolt 270 will rotate. The deadbolt 270 is dimensioned to protrude through either cut-out 238 in the housing 210 so that the rotary deadbolt assembly E can be configured for a right-hand or left-hand door. The deadbolt 270 includes an elliptical opening 300 radially aligned with the circular opening 296 and pin 298 that receives the pin 288 extending from the rack 284.

With reference back to FIG. 9, a spacer 304 mounts in the housing 210 attaching to the front wall 212 via a fastener 306 received in a fastener opening 308 of the spacer. The spacer 304 spaces the rotary deadbolt 270 from the first wall 212 of the housing 210 to allow the rack 284 to move between the rotary deadbolt 270 and the first wall 212. The spacer 304 also includes an aperture 310 that is dimensioned to receive the pin 298 about which the rotary deadbolt 270 rotates. As most easily seen in FIG. 11, the spacer 304 includes a side notch 312 in which the tail 286 that extends from the rack 284 travels. The side notch 312 can provide a mechanical stop for the upward-most and downward-most linear movement of the rack 284 and can prevent unwanted torquing of the rack. As also noticeable in FIG. 11, the top cover member 254 includes two rear cut-out sections 314 in which the rack 284 can move to provide a linear track for the rack's movement to limit any undesired rotational movement.

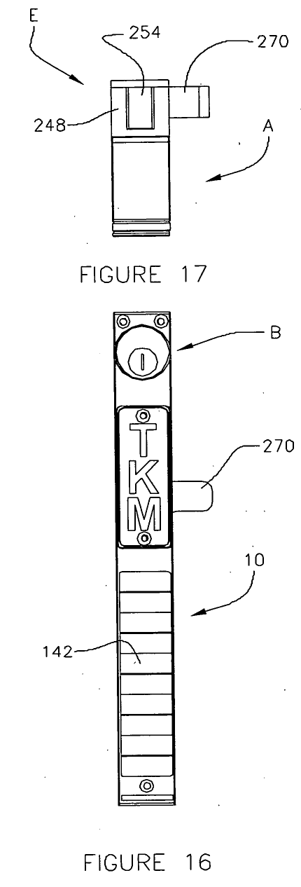

The rotary deadbolt assembly can be configured in the field to provide for a right-hand or left-hand deadbolt assembly. FIGS. 10-13 depict the gear train assembled in a left-hand configuration. To change to a right-hand configuration, such as that shown in FIGS. 16 and 17, the rack 284 is moved to engage the second pinion 282. The tail 286 is removed from the rack 284 and reconnected in its other orientation. Both the spacer 304 and the rotary deadbolt 270 are flipped 1800 and now the rotary deadbolt can rotate towards the right, as depicted in FIGS. 16 and 17.

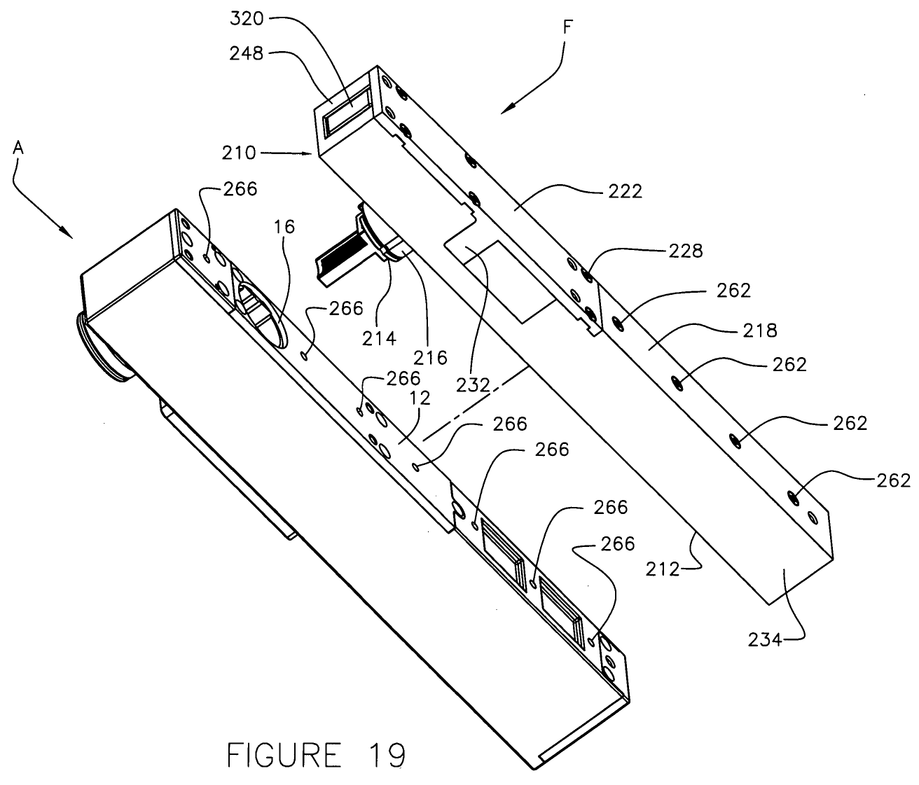

With reference to FIG. 19, a linear deadbolt assembly F will be described. Many of the components used in the linear deadbolt assembly can also be used in the rotary deadbolt assembly E. Furthermore, it is desirable for the ease of manufacture, as well as to provide the end-user multiple environments where the deadbolt assembly can be used, to use many of the same components in each of the linear deadbolt assembly F and the rotary deadbolt assembly E. Accordingly, many of the reference numerals used to describe the rotary deadbolt assembly E will also be used to describe the linear deadbolt assembly F. Nevertheless, it is to be understood that other configurations can be used for each of the assemblies and usage of the same reference numerals is only for the convenience of the reader.

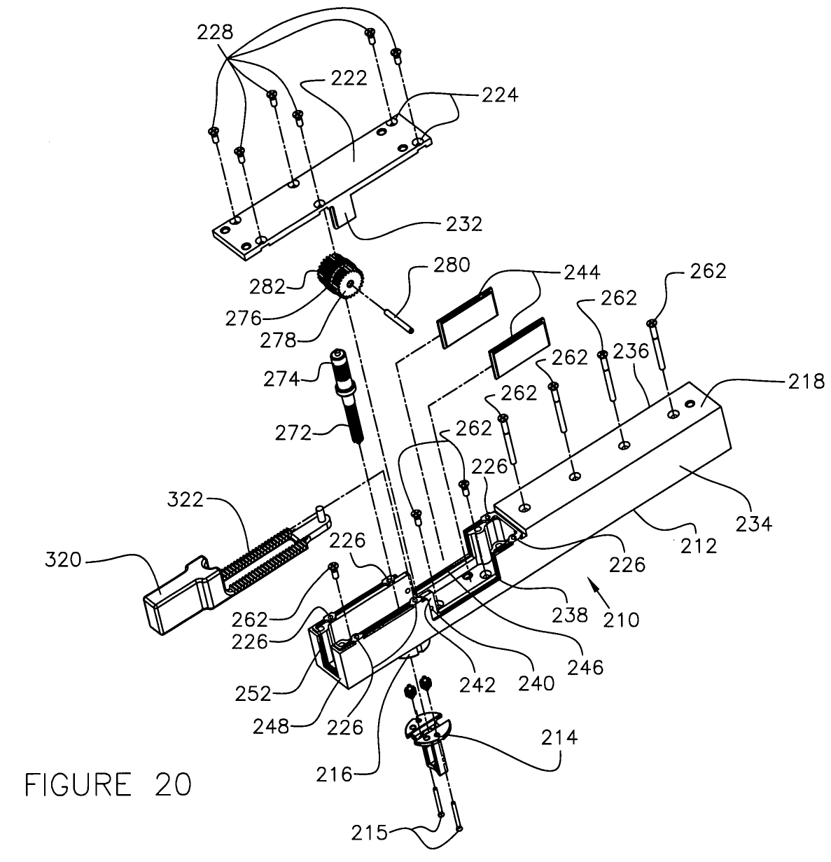

The linear deadbolt assembly F includes a housing 210, a front wall 212 and a rear wall 218 similar to the rotary deadbolt assembly E. Also, a gear mounting chassis 214 attaches to a cylindrical boss 216 using fasteners 215. A removable rear panel 222 attaches to the rear of the housing 210. The removable rear panel includes openings 224 that align with openings 226 in the housing 210 to receive fasteners 228 to selectively attach the removable rear panel 222 to the housing 210. The removable rear panel 222 also includes appendages 232 that depend from the rear panel. As more clearly seen in FIG. 20, the housing 210 further includes a first side wall 234 and a second side wall 236. The first side wall includes a rectangular cut-out 238. A recessed surface 242 is formed in the first side wall 234 adjacent an upper edge of the rectangular cut-out 238. Similarly, a second cut-out 246 is also provided in the second side wall 236 and aligns with the first cut-out 238. Each cut-out 238 includes an opening 240. In this embodiment, two side wall covers 244 can be provided to cover each cut-out 238 and 246.

The housing 210 also includes a top wall 248 in which a top cut-out 252 is formed. In this embodiment, however, a linear deadbolt 320 selectively extends from the top cut-out 252, as seen in FIG. 22 and which will be described in more detail below.

Mounting screws of different lengths 262 are received in openings 264 in the housing 210 and also in openings 166 (FIG. 19) in the housing 10 of the automated lock assembly A to selectively attach the linear deadbolt assembly F housing 210 to the automated lock assembly housing 10.

The linear deadbolt 320 is driven by a transmission including the axially elongated gear 272, the worm 274, the corresponding worm gear 276, the first pinion 278, the second pinion 282, and the axle 280 each of which were described above with relation to the rotary deadbolt assembly E.

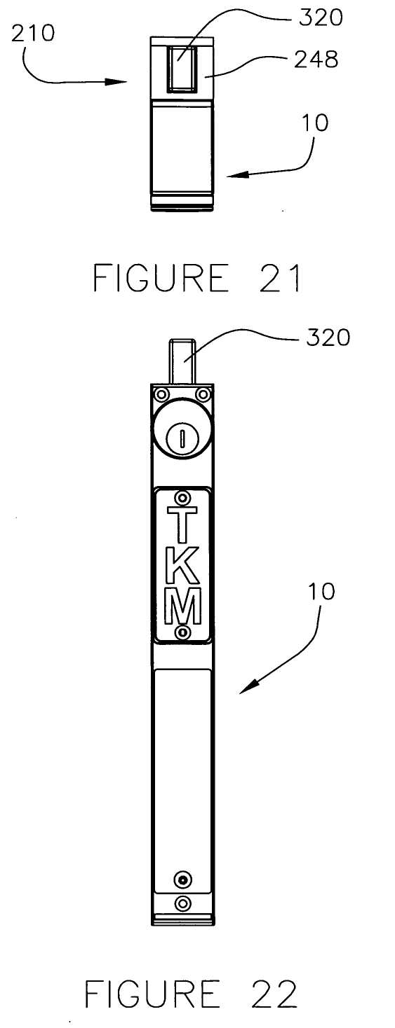

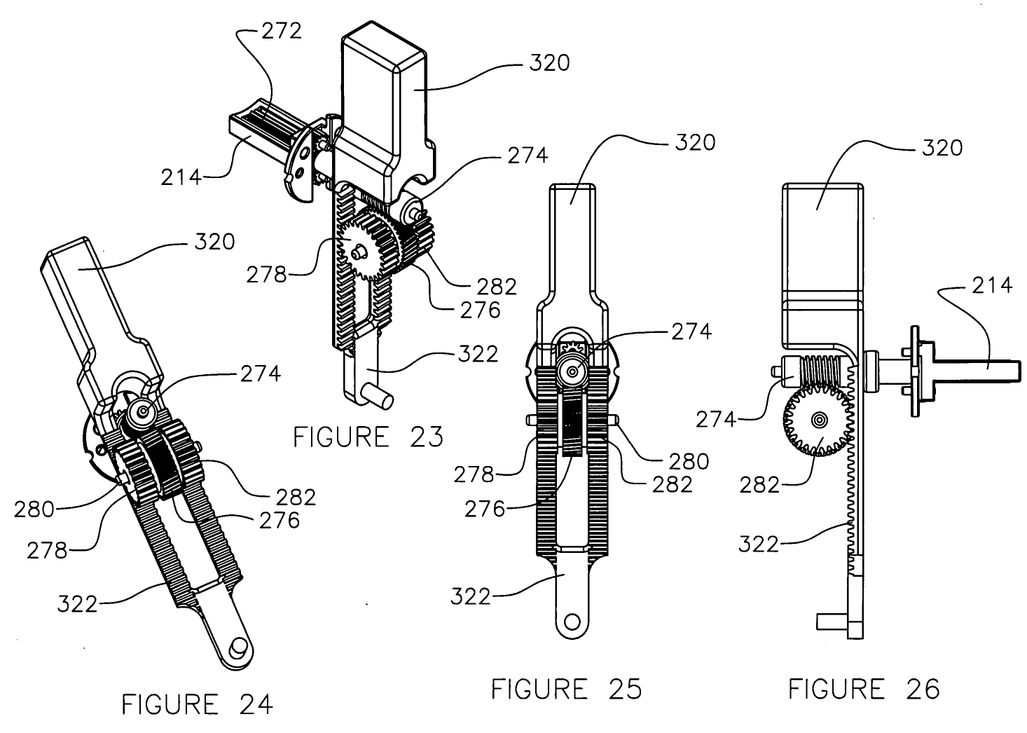

With reference to FIGS. 23-26, the input gear 272 drives the worm 274, which drives the worm gear 276, which drives the attached pinions 278 and 282. The pinions 278 and 282 engage a double rack 322 that depends from and is attached to the linear deadbolt 320. The double rack 322 includes two racks that are spaced apart from one another such that the worm gear 276 does not contact either rack. In alternative embodiments, only one rack may be provided. Accordingly, the worm assembly translates rotational movement of the input gear 272 into linear movement of the deadbolt 320. The rack 322 is long enough to allow the deadbolt 320 to extend from the top cut-out 252, as shown in FIG. 21. In each embodiment, the input gear 272 and the worm 274 are attached to one another and concentric with one another. Also, the worm gear 276 is attached to each pinion 278 and 282 and concentric with each pinion.

The assemblies were defined with reference to preferred embodiments. Obviously modifications will occur to others upon reading and understanding the preceding description. The invention is intended to cover all modifications that come within the scope of the appended claims and their equivalents.

1. An automated assembly for operating a lock in a door, the assembly comprising:
a housing;
a lock adapter assembly having at least a portion extending away from the housing and shaped to be received in an opening in a door lock that was once occupied by a lock cylinder, the lock adapter assembly including a mounting member for mounting a cam that corresponds to the lock cylinder; and
a powered drive mechanism for driving the lock adapter assembly.

2. The assembly of claim 1, further comprising a conversion cam for mounting to the lock cylinder, the conversion cam cooperating with at least one of the lock adapter assembly and the powered drive mechanism such that movement of the conversion cam results in the mounting member moving the cam to operate the door lock.

3. The assembly of claim 2, wherein the conversion cam operatively engages the lock adapter assembly.

4. The assembly of claim 2, further comprising a sensor in electrical communication with the powered drive mechanism, wherein the conversion cam cooperates with the sensor to deliver a signal to the powered drive mechanism.

5. The assembly of claim 1, wherein the lock adapter assembly is adjustable with respect to the housing such that the lock adapter assembly can move along an axis to accommodate different door thicknesses while still engaging the transmission.

6. The assembly of claim 5, wherein the lock adapter assembly includes an axially elongated gear adapted to engage the transmission at different locations along the gear.

7. The assembly of claim 1, further comprising an internal power source disposed in the housing and in electrical communication with the powered drive mechanism.

8. The assembly of claim 7, wherein the internal power source comprises a solar cell.

9. The assembly of claim 1, further comprising a receiver in electrical communication with the drive mechanism, wherein the receiver receives a remote signal that controls delivery of power to the drive mechanism.

10. The assembly of claim 1, further comprising a handle and sensor assembly for delivering a signal to the powered drive mechanism.

11. A method for converting a manual cylinder lock to an automated cylinder lock, the method comprising:
removing a lock cylinder from a door lock, whereby an opening remains in a door;
removing a cam that cooperated with the door lock from the lock cylinder;
attaching the cam that was removed from the lock cylinder to a lock adapter assembly of an automated lock assembly comprising the lock adapter assembly, a powered drive assembly for powering the lock adapter assembly, and a housing for the lock adapter assembly; and
mounting the automated lock assembly to the door such that at least a portion of the lock adapter assembly fits into the cylindrical opening of the door.

12. The method of claim 11, wherein the mounting step allows for adjusting a distance the lock adapter assembly extends from the housing.

13. An assembly comprising:
a housing;
a powered drive mechanism disposed in the housing;
a gear train operatively connected to the powered drive mechanism and comprising interchangeable components to drive a deadbolt; and
a power source disposed in the housing and in electrical communication with the powered drive mechanism.

14. The assembly of claim 13, further comprising a solar panel attached to the housing in electrical communication with the power source.

15. The assembly of claim 13, further comprising a deadbolt operatively connected to the gear train, wherein the gear train is adaptable to drive the deadbolt in two different directions that are offset 180° from one another.

16. The assembly of claim 15, wherein the gear train translates rotational movement into linear movement.

17. The assembly of claim 16, wherein the deadbolt is driven by the gear train along a linear path.

18. The assembly of claim 16, wherein the housing includes an opening disposed in at least one of a top and bottom of the housing dimensioned so that the deadbolt can pass through the opening.

19. The assembly of claim 13, wherein the housing includes first and second deadbolt openings each having at least substantially the same dimensions disposed on opposite sides of the housing.

20. The assembly of claim 13, further comprising a receiver in electrical communication with the drive mechanism, wherein the receiver receives a remote signal that controls delivery of power to the drive mechanism.
